(19) United States
(12) Patent Application Publication
(10) Pub. No.: US 2013/0040185 A1
(43) Pub. Date: Feb. 14, 2013

(54) SEPARATOR FOR RECHARGEABLE LITHIUM BATTERY, AND ELECTRODE STRUCTURE AND RECHARGEABLE LITHIUM BATTERY INCLUDING THE SAME

(71) Applicant: Hironari Takase, Yokohama-shi (JP)

(72) Inventor: Hironari Takase, Yokohama-shi (JP)

(21) Appl. No.: 13/569,030

(22) Filed: Aug. 7, 2012

(30) Foreign Application Priority Data
Aug. 8, 2011 (JP) 2011-173307
Jul. 9, 2012 (KR) 10-2012-0074641

(51) Int. Cl. H01M 2/14

(52) U.S. Cl. 429/145; 429/144

(57) ABSTRACT

A separator for a rechargeable lithium battery include a substrate including a plurality of first pores and a porous layer on the substrate, the porous layer including a plurality of second pores, the second pores having a larger average size than the first pores. A rechargeable lithium battery may include the separator.

### CROSS-REFERENCE TO RELATED APPLICATIONS

This application claims priority to and the benefit of Japanese Patent Application No. 2011-173307 filed in the Japanese Patent Office on Aug. 8, 2011, and Korean Patent Application No. 10-2012-0074641 filed in the Korean Intellectual Property Office on Jul. 9, 2012, the entire contents of both of which are incorporated herein by reference.

### BACKGROUND

1. Field

The present invention relates to a separator for a rechargeable lithium battery, an electrode structure including the separator, and a rechargeable lithium battery including the same.

2. Description of the Related Art

Lithium ion secondary batteries are a type of rechargeable battery. Fluorinated solvents and/or additives may sometimes be used in the electrolyte. A lithium ion secondary battery typically includes an electrode assembly that includes a negative electrode and a positive electrode separated by a separator and an electrolyte. For example, electrolytes may include fluorine-containing ether-based solvents, fluorinated cyclic carbonates, cyclohexyl fluorobenzene, fluorobiphenyl, or methylnonafluorobutyl ether.

However, improvements in the cycle-life of Lithium ion secondary batteries generally fabricated as described above are limited.

### SUMMARY

Aspects of embodiments of the present invention are directed to a separator for a rechargeable lithium battery having improved cycle-life.

In some embodiments, a separator for a rechargeable lithium battery includes a substrate including a plurality of first pores and a porous layer on a surface of the substrate, the porous layer including a plurality of second pores. The second pores may have a larger average size than the first pores. The porous layer may be on both of the surfaces of the substrate.

The second pores may have an average size in a range of about 1 μm to about 2 μm. The first pores may have an average size in a range of about 0.1 μm to about 0.5 μm.

The separator may have a porosity in a range of about 39% to about 58%. The porous layer may have a higher porosity than the substrate. In some embodiments, the substrate has a porosity in a range of about 38% to about 44%.

The porous layer may have a thickness in a range of about 1 μm to about 5 μm. The separator may have a total thickness in a range of about 10 μm to about 25 μm.

In some embodiments, a rechargeable lithium battery includes a positive electrode including a positive active material, a negative electrode including a negative active material, a separator as described above between the positive electrode and the negative electrode, and an electrolyte solution comprising a fluorinated ether compound.

In some embodiments, the porous layer is between the substrate of the separator and the negative electrode. In some embodiments, the porous layer is on both sides of the substrate of the separator.

The electrolyte solution is impregnated into the first and second pores.

The fluorinated ether compound may be selected from 2,2,2-trifluoro ethyl methyl ether, 2,2,2-trifluoroethyl difluoro methyl ether, 2,2,3,3,3-penta fluoro propyl methyl ether, 2,2,3,3,3-pentafluoro propyl difluoro methyl ether, 2,2,3,3,3-penta fluoropropyl-1,1,2,2-tetrafluoroethyl ether, 1,1,2,2-tetra fluoro ethyl methyl ether, 1,1,2,2-tetra fluoro ethyl ether, 1,1,2,2-tetra fluoro ethyl propyl ether, 1,1,2,2-tetra fluoro ethyl butyl ether, 1,1,2,2-tetra fluoro ethyl isobutyl ether, 1,1,2,2-tetra fluoro ethyl isopentyl ether, 1,1,2,2-tetrafluoroethyl-2,2,2-trifluoro ethyl ether, 1,1,2,2-tetrafluoroethyl-2,2,3,3-tetra fluoro propyl ether, hexa fluoro isopropyl methyl ether, 1,1,3,3,3-penta fluoro-2-trifluoro methyl propyl methyl ether, 1,1,2,3,3,3-hexa fluoro propyl methyl ether, 1,1,2,3,3,3-hexa fluoro propyl ethyl ether, 2,2,3,4,4,4-hexafluorobutyl difluoro methyl ether, or combinations thereof. The electrolyte solution may include the fluorinated ether compound in a range of about 30 to about 60 volume % based on the total volume of the electrolyte solution.

The electrolyte solution may further include monofluoroethylene carbonate. The electrolyte solution may include the monofluoroethylene carbonate in a range of about 10 to about 30 volume % based on the total volume of the electrolyte solution.

The electrolyte solution may further include a lithium salt in a range of about 1.15 to about 1.5 mol/L.

In some embodiments, an electrode assembly for a rechargeable lithium battery includes a positive electrode including a positive active material, a negative electrode including a negative active material, and a separator between the positive electrode and the negative electrode, the separator including a substrate and a porous layer on a side of the substrate, the substrate including a plurality of first pores and the porous layer including a plurality of second pores. The second pores may have a larger average size than the first pores, and the porous layer may be between the substrate and the negative electrode.

In some embodiments, a rechargeable lithium battery including the separator may have an improved cycle-life.

### BRIEF DESCRIPTION OF THE DRAWINGS

FIG. 1 is a schematic cross-sectional view of a rechargeable lithium battery according to one embodiment.

FIG. 2 is a graph of the cycle-life of rechargeable lithium battery cells according to Examples 1 to 3 and Comparative Example 1.

FIG. 3 is a graph of the cycle-life of rechargeable lithium battery cells according to Examples 4 to 8 and Comparative Examples 2 and 3.

FIG. 4 is a graph of the cycle-life of rechargeable lithium battery cells according to Examples 9 to 17 and Comparative Example 4.

FIG. 5 is a graph of the cycle-life of rechargeable lithium battery cells according to Examples 18 to 25.

FIG. 6 is a graph of the cycle-life of rechargeable lithium battery cells according to Examples 26 to 34.

FIG. 7 is an enlarged view of FIG. 6 showing the discharge capacity ranging from 90 to 100 mAh.

FIG. 8 is a graph of the cycle-life of rechargeable lithium battery cells according to Examples 35 to 45.

FIG. 9 is an enlarged view of FIG. 8 showing the discharge capacity ranging from 88 to 99 mAh.

### DETAILED DESCRIPTION

Exemplary embodiments will hereinafter be described in detail. However, these embodiments are exemplary, and this disclosure is not limited thereto.

Hereinafter, exemplary embodiments are illustrated in more detail with reference to the accompanied drawings, and this disclosure is not limited thereto.

Constituent elements substantially having the same function in the specification and drawings are provided with the same or similar reference numbers but may not be repetitively illustrated.

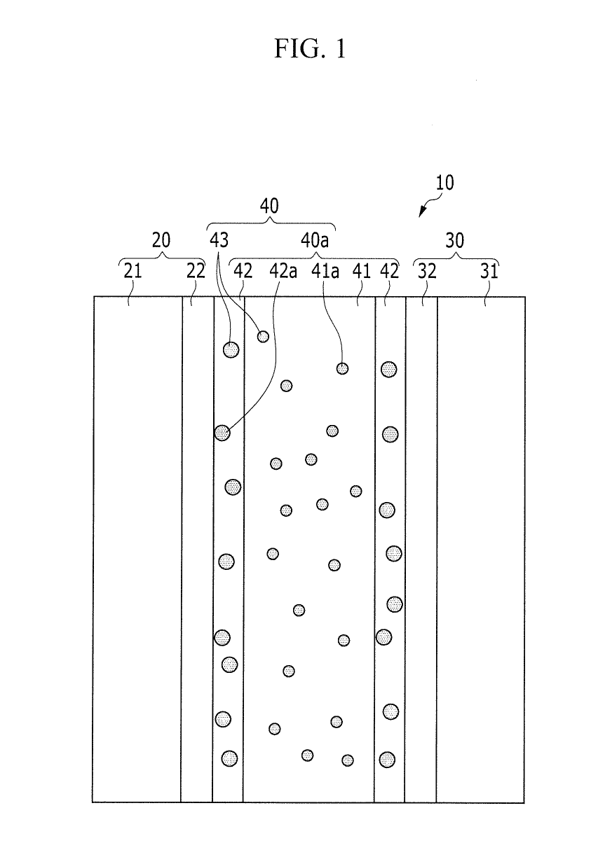

FIG. 1 is a schematic view showing a cross-section of a rechargeable lithium battery according to one embodiment.

Referring to FIG. 1, a rechargeable lithium battery 10 according to one embodiment includes a positive electrode 20, a negative electrode 30, and a separator layer 40.

The rechargeable lithium battery 10 may reach a charge voltage (an oxidation reduction potential) in a range of greater than or equal to about 4.3 V (vs. Li/Li+) to less than or equal to about 5.0 V. In some embodiments, the rechargeable lithium battery 10 may have a charge voltage in a range of greater than or equal to about 4.5 V to less than or equal to about 5.0 V.

The rechargeable lithium battery 10 has no particular limit about its shape. For example, the rechargeable lithium battery 10 may be cylindrical, prismatic, laminated type, a button-type, or the like.

The separator layer 40 includes a separator 40a and an electrolyte solution 43.

The separator 40a includes a substrate 41 and a porous layer 42.

The substrate 41 may be formed of a resin such as polyethylene, polypropylene, and/or the like and may include a plurality of the first pores 41a.

The first pores 41a may be spherically shaped as shown in FIG. 1 but the shape of the first pores is are not limited thereto, and may have any suitable shape.

The first pores 41a may have an average size (or median size) in a range of about 0.1 μm to about 0.5 μm. The measurement of the average size of the first pores 41a may refer to a diameter (e.g., a diameter of a sphere), that is, the longest length of a chord of the sphere. The average size of the first pores 41a may be measured using an auto porosimeter (such as the AutoporeIV manufactured by SHIMADZU Corporation). Specifically, equipment may be used to measure distribution of the first pores 41a and to calculate a representative value of the pore diameter having the greatest distribution.

In addition, the diameter of the first pores 41a on the surface of the substrate 41 may be measured using a scanning electron microscope (such as the JSM-6060 manufactured by JEOL Ltd.). Such equipment measures each first pore 41a on the surface.

The substrate 41 may have a porosity in a range of about 38% to about 44%. When the substrate 41 has a porosity within the range, its cycle-life is very good.

The porosity of the substrate 41 is obtained as a percentage by dividing the total volume of the first pores 41a by the total volume of the substrate 41, that is, the volume sum of the resin and the first pores 41a of the substrate 41.

The porosity of the substrate 41 may be measured using an auto porosimeter (such as the AutoporeIV manufactured by SHIMADZU Corporation).

In some embodiments, the substrate 41 has a thickness in a range of about 6 μm to about 19 μm. When the substrate 41 has a thickness within this range, its cycle-life is very good.

The porous layer 42 may be formed of a material different from the substrate 41. For example, the porous layer may be formed of resins such as polyvinylidene fluorides, polyamideimides, aramids (aromatic polyamides), and/or the like and may include a plurality of the second pores 42a.

The second pores 42a may have a spherical shape as shown in FIG. 1 but the shape of the second pores 42a is not limited thereto. Rather, the second pores 42a may have any suitable shape.

The second pores 42a have a greater average size than the first pores 41a.

The second pores 42a may have an average size ranging from about 1 μm to about 2 μm. The measurement of the average size of the second pores 42a may be referring to the diameter of the spherical pores, that is, the longest length of a chord of a sphere. The diameter of the second pores 42a may be measured using a scanning electron microscope (such as the JSM-6060 manufactured by JEOL Ltd.). The equipment measures the diameter of each second pore 42a.

The porous layer 42 may include polyvinylidene fluoride, for example, KF Polymer #1700, #9200, #9300, and/or the like made by KUREHA Co. The polyvinylidene fluoride may have a weight average molecular weight in a range of about 500,000 to about 1,000,000.

The porous layer 42 may be formed or may be commercially available.

In some embodiments, the separator 40a may have a porosity in a range of about 39% to about 58%. When the separator 40a has a porosity within this range, cycle-life is very good. The porosity of the separator 40a is obtained as a percentage by dividing the volume sum of the first pores 41a and the second pores 42a by the total volume of the separator 40a, that is, the volume sum of the resin and the first pores 41a of the substrate 41 and the resin and the second pores 42a of the porous layer 42.

The porosity of the separator 40a may be measured using an auto porosimeter (such as the AutoporeIV manufactured by SHIMADZU Corporation).

The separator 40a has higher porosity than the substrate 41. Furthermore, in some embodiments, the porosity of the porous layer 42 (i.e., the number of the second pores 42a) may be higher than the porosity of the substrate 41.

The porous layer 42 may have a thickness ranging from about 1 μm to about 5 μm.

In some embodiments, the thickness of the separator 40a, that is, the thickness of the sum of the substrate 41 and the porous layer 42 is in a range of about 10 μm to about 25 μm. When the porous layer 42 and the separator 40a respectively have a thickness within the above range, cycle-life is very good.

The porous layer 42 may be formed on both sides of the substrate 41, that is, the side of the substrate 41 facing the positive electrode 20 and the other side thereof facing the negative electrode 30. However, according to another embodiment, the porous layer 42 may be formed only one side of the substrate facing the negative electrode 30. The porous layer 42 formed on both sides of the substrate 41 may improve cycle-life of the rechargeable lithium battery more than the one formed on only one side thereof.

In some embodiments, the substrate 41 has an air transmission, specifically defined as JIS P8117, in a range of about 250 to about 300 sec/100 cc but the air transmission of the substrate 41 is not limited thereto. In some embodiments, the separator 40a has an air transmission in a range of about 220 to about 340 sec/100 cc but the air transmission of the separator 40a is not limited thereto. When the substrate 41 and the separator 40a respectively have air transmissions within the above range, cycle-life will be improved.

The air transmission of the substrate 41 and the separator 40a may be measured using a GURLEY air transmission meter G-B2 (manufactured by Dongyang Creditech Co. Ltd.).

The separator 40a may be fabricated by coating a coating solution including a resin and a water-soluble organic solvent for forming the porous layer 42 on the substrate 41 and then, coagulating the resin and removing the water-soluble organic solvent. In particular, the separator 40a is fabricated as follows.

First, a coating solution is prepared by mixing the resin and the water-soluble organic solvent in a mass ratio in a range of about 5 to 10:about 90 to 95. Next, the coating solution is coated to be about 1 to about 5 μm thick on both sides or one side of the substrate 41. Then, the coated substrate 41 is treated with a coagulating solution to coagulate the resin in the coating solution, fabricating the separator 40a. The separator 40a is washed and dried to remove the water and the water-soluble organic solvent therefrom.

The water-soluble organic solvent may include, for example, N-methyl-2-pyrrolidone, dimethyl acetamide (DMAc), tripropyleneglycol (TPG), and/or the like.

The treatment with a coagulating solution may include, for example, impregnating the coagulating solution in the coated substrate 41, and strongly blowing the coagulating solution on the coated substrate 41. The coagulating solution may be prepared by mixing, for example, water with the water-soluble organic solvent. The water may be mixed in a range of about 40 to about 80 volume % based on the total volume of the coagulating solution.

The electrolyte solution 43 is then permeated in the first pores 41a and the second pores 42a. The electrolyte solution 43 may include a lithium salt as an electrolyte and a fluorinated ether compound in which fluorine is substituted for at least a one of the hydrogen atoms. The electrolyte solution 43 may further include monofluoroethylene carbonate.

The lithium salt may include LiPF₆, LiBF₄, LiClO₄, LiSO₃CF₃, LiN(SO₂CF₃), LiN(SO₂CF₂CF₃), LiC(SO₂CF₂CF₃)₃, LiC(SO₂CF₃)₃, LiI, LiCl, LiF, LiPF₆(SO₂CF₃), LiPF₄(SO₂CF₃)₂, and/or the like. In some embodiments, the lithium salt is included at a concentration in a range of about 1.15 to about 1.5 mol/L. In some embodiments, the lithium salt is included at a concentration in a range of about 1.3 to about 1.45 mol/L. When the lithium salt is included within the above described concentration ranges, the cycle-life of the battery is very good.

The fluorinated ether compound includes fluorine substituted for hydrogen in ether compounds. The fluorinated either compound has improved oxidation resistance.

The fluorinated ether compound may be at least one selected from 2,2,2-trifluoroethyl methyl ether (CF₃CH₂OCH₃), 2,2,2-trifluoroethyl difluoromethyl ether (CF₃CH₂OCHF₂), 2,2,3,3,3-pentafluoropropyl methyl ether (CF₃CF₂CH₂OCH₃), 2,2,3,3,3-pentafluoropropyl difluoromethyl ether (CF₃CF₂CH₂OCHF₂), 2,2,3,3,3-pentafluoropropyl-1,1,2,2-tetrafluoroethyl ether (CF₃CF₂CH₂OCF₂CF₂H), 1,1,2,2-tetrafluoroethyl methyl ether (HCF₂CF₂OCH₃), 1,1,2,2-tetrafluoroethyl ethyl ether (HCF₂CF₂OCH₂CH₃), 1,1,2,2-tetrafluoroethyl propyl ether (HCF₂CF₂OC₃H₇), 1,1,2,2-tetrafluoroethyl butyl ether (HCF₂CF₂OC₄H₉), 1,1,2,2-tetrafluoroethyl isobutyl ether (HCF₂CF₂OCH₂CH(CH₃)₂), 1,1,2,2-tetrafluoroethyl isopentyl ether (HCF₂CF₂OCH₂C(CH₃)₃), 1,1,2,2-tetrafluoroethyl-2,2,2-trifluoro ethyl ether (HCF₂CF₂OCH₂CF₃), 1,1,2,2-tetrafluoroethyl-2,2,3,3-tetrafluoro propyl ether (HCF₂CF₂OCH₂CF₂CF₂H), hexafluoroisopropyl methyl ether ((CF₃)₂CHOCH₃), 1,1,3,3,3-pentafluoro-2-trifluoromethylpropyl methyl ether ((CF₃)₂CHCF₂OCH₃), 1,1,2,3,3,3-hexafluoropropyl methyl ether (CF₃CHFCF₂OCH₃), 1,1,2,3,3,3-hexafluoropropyl ethyl ether (CF₃CHFCF₂OCH₂CH₃) and 2,2,3,4,4,4-hexafluorobutyl difluoromethyl ether (CF₃CHFCF₂CH₂OCHF₂), and/or a combination thereof. The fluorinated ether compound may be used singularly, or a mixture of the fluorinated ether compound may be used.

In some embodiments, the fluorinated ether compound may be included in a range of about 30 to about 60 volume % based on the total volume of the electrolyte solution 43. In other embodiments, the fluorinated ether compound may be included in a range of about 35 to about 50 volume % based on the total volume of the electrolyte solution 43. When the fluorinated ether compound is included within the above described volume ratios, cycle-life is very good.

In some embodiments, monofluoroethylene carbonate may be included in a range of about 10 to about 30 volume % based on the total volume of the electrolyte solution 43. In some embodiments, monofluoroethylene carbonate may be included in a range of about 15 to about 20 volume % based on the total volume of the electrolyte solution 43. When the monofluoroethylene carbonate is included within the above described volume ranges, cycle-life is very good.

The electrolyte solution 43 may further include an additive such as a negative electrode Solid Electrolyte Interface (SEI) formation agent, a surfactant, and/or the like.

The additive may include, for example, vinylene carbonate, vinylethylene carbonate, phenylethylene carbonate, succinic anhydride, lithium bisoxalate, lithium tetrafluoroborate, dinitrile compounds, propane sultone, butane sultone, propene sultone, 3-sulfolane, fluorinated allyl ethers, fluorinated acrylates, and/or the like.

The dinitrile compounds may include, for example, succinonitrile, adiponitrile, and/or the like.

The fluorinated allyl ethers may include, for example, (2H-perfluoro ethyl)-2-propenyl ether, allyl-2,2,3,3,4,4,5,5-octafluoropentyl ether, heptafluoro-2-propyl aryl ether, and/or the like.

The fluorinated acrylates may include, for example, 1H-pentafluoropropyl acrylate, 2,2,3,3-tetrafluoropropyl acrylate, and/or the like.

In some embodiments, the additive may be included in a range of about 0.01 to about 5.0 mass % based on the total mass of the electrolyte solution. When the additive is included within the above described mass range, cycle-life is very good.

The positive electrode 20 includes a current collector 21 and a positive active material layer 22. The current collector 21 may include any conductor, for example, aluminum, stainless steel, nickel-plated steel, and/or the like. The positive active material layer 22 includes a positive active material and additionally, a conductive material and a binder.

The positive active material may include a solid solution oxide including lithium but it is not particularly limited. That is, any positive active material that chemically intercalates or deintercalates lithium ions may be used.

The solid solution oxide may include, for example, LiₐMnₓCo_{y}Ni_{z}O₂ (1.150≦a≦1.430, 0.45≦x≦0.6, 0.10≦y≦0.15, and 0.20≦z≦0.28), LiMnₓCo_{y}Ni_{z}O₂ (0.3≦x≦0.85, 0.10≦y≦0.3, and 0.10≦z≦0.3), LiMn_{1.5}Ni_{0.5}O₄, and/or the like.

in some embodiments, the positive active material may be included in a range of greater than or equal to about 85 mass % to less than or equal to about 96 mass % based on the total mass of the positive active material layer 22. In other embodiments, the positive active material may be included in a range of greater than or equal to about 88 mass % to less than or equal to about 94 mass % based on the total mass of the positive active material layer 22. When the positive active material is included within the above described ranges, cycle-life is good, and the positive electrode 20 has high energy density.

The energy density of the positive electrode 20 may be, for example, greater than or equal to about 530 Wh/l (i.e., 180 Wh/kg).

The conductive material may include, for example, carbon black such as Ketjen black, acetylene black, and/or the like, natural graphite, artificial graphite, and/or the like but the conductive material is not limited thereto. Any material that increases conductivity of the positive electrode may be used as the conductive material.

In some embodiments, the conductive material may be included in a range of greater than or equal to about 3 mass % to less than or equal to about 10 mass % based on the total mass of the positive active material layer 22. In other embodiments, the conductive material may be included in a range of greater than or equal to about 4 mass % to less than or equal to about 6 mass % based on the total mass of the positive active material layer 22. When the conductive material is included within the above described ranges, cycle-life is good, and the positive electrode 20 energy density is high.

The binder may include, for example, polyvinylidene fluoride, an ethylene/propylene/diene terpolymer, a styrene/butadiene rubber, an acrylonitrile/butadiene rubber, a fluorine rubber, polyvinyl acetate, polymethylmethacrylate, polyethylene, nitrocellulose, and/or the like. However, any suitable material that binds the positive active material and the conductive material on the current collector 20 may be used.

In some embodiments, the binder may be included in a range of greater than or equal to about 3 mass % to less than or equal to about 7 mass % based on the total mass of the positive active material layer 22. In other embodiments, the binder may be included in a range of greater than or equal to about 4 mass % to less than or equal to about 6 mass % based on the total mass of the positive active material layer 22. When the binder is included within the above described ranges, cycle-life is good, and the energy density of the positive electrode 20 is high.

The positive active material layer 22 has no particular density limit and in some embodiments, for example, it may have a density in a range of greater than or equal to about 2.0 g/cm³ to less than or equal to about 3.0 g/cm³. In other embodiments, the positive active material layer 22 has a density in a range of greater than or equal to about 2.5 g/cm³ to less than or equal to about 3.0 g/cm³. When the positive active material layer 22 has density within the above described ranges, cycle-life is good, and positive electrode 20 energy density is high. On the other hand, when the density of the positive active material layer 22 is over about 3.0 g/cm³, positive active material particles therein may be destroyed and do damage (e.g., electrical damage) to other particles. As a result, the positive active material may be used at a lower rate and thus, deteriorate original discharge capacity and easily cause polarization. In addition, the positive active material may be charged up to greater than or equal to a predetermined or set potential and thereby cause decomposition of the electrolyte solution and elution of transition elements, thereby deteriorating cycle life characteristics. Accordingly, the positive active material layer 22 should have a density within the above described ranges.

The density of the positive active material layer 22 may be obtained by dividing the surface density of the positive active material layer 22 by the thickness of the positive active material layer 22. This may be done after the positive active material is pressed, as discussed below.

The positive active material, the conductive material, and the binder may be dispersed in an organic solvent, for example, N-methyl-2-pyrrolidone, to prepare a positive active material layer slurry. The slurry may then be coated on a current collector 21, dried, and pressed, fabricating a positive electrode.

The method of coating the slurry on the current collector 21 is not particularly limited, and may include, for example, a knife coating, a gravure coating, and/or the like.

The negative electrode 30 includes a current collector 31 and a negative active material layer 32. The current collector 31 may be any conductor, for example, aluminum, stainless steel, nickel-plated steel, and/or the like. The negative active material layer 32 may include a negative active material and additionally, a binder.

The negative active material may include, for example, a graphite active material such as artificial graphite, natural graphite, a mixture of artificial graphite and natural graphite, natural graphite coated with artificial graphite, and/or the like; silicon or tin; a mixture of silicon oxide or tin oxide particulate and the graphite active material; silicon particulate or tin particulate; a silicon-containing alloy or tin-containing alloy; a titanium oxide-based compound such as Li₄Ti₅O₁₂; and/or the like. The silicon oxide may be represented by SiOₓ (0≦x≦2). However, the negative active material may include any material that can electrochemically intercalate and deintercalate lithium ions.

In some embodiments, the negative active material may be included in a range of greater than or equal to about 90 mass % to less than or equal to about 98 mass % based on the total mass of the negative active material layer 32. When the negative active material is included within the above described range, cycle-life is good and energy density of the negative electrode is high.

The binder may be the same as included the aforementioned positive active material layer 22.

When the negative active material layer 32 is coated on the current collector 31, carboxymethyl cellulose (CMC) may be used as a thickener in a mass ratio range of greater than or equal to about 1 part CMC/10 parts of the binder to less than or equal to the mass of the binder (i.e., 1 part CMC/1 part binder).

In some embodiments, the thickener and the binder may be included in a range of greater than or equal to about 1 mass % to less than or equal to about 10 mass % based on the total mass of the negative active material layer 32. When the thickener and the binder are used within this range, cycle-life is good, and the energy density of the negative electrode is high.

The density of the negative active material layer 32 is not particularly limited, but, for example, it may have a density in a range of greater than or equal to about 1.0 g/cm³ to less than or equal to about 2.0 g/cm³. When the negative active material layer 32 has a density within this range, cycle-life is good, and the energy density of the negative electrode is high. The density of the negative active material layer 32 may be obtained by dividing the surface density of the negative active material layer 32 by the thickness of the negative active material layer 32. This may be done after the negative active material is pressed (if it is optionally pressed).

The negative active material and the binder may be dispersed in a solvent, for example, N-methyl-2-pyrrolidone or water, to prepare a negative active material layer slurry. The slurry is coated on the current collector 31 and dried, fabricating the negative electrode.

The coating method is not particularly limited and may include, for example, knife coating, gravure coating, and/or the like.

The rechargeable lithium battery 10 may be fabricated in the following method.

The separator 40a is disposed between the positive electrode 20 and the negative electrode 30 to fabricate an electrode structure. When the porous layer 42 is formed on only one side of the substrate 41, the negative electrode 30 is positioned to face the porous layer 42.

The electrode structure may be processed to have a desired shape, for example, to be cylindrical, prismatic, laminated type, button-type, or the like and then, inserted into the a suitable container.

Then, the electrolyte solution is injected into the container, so that the electrolyte solution may impregnate the separator 40a, and the pores in the separator 40a may be permeated with the electrolyte solution, thereby fabricating the rechargeable lithium battery 10.

In the rechargeable lithium battery 10, the second pores 42a formed in the porous layer 42 have different characteristics from the first pores 41a formed in the substrate 41, as described above. Because the electrolyte solution 43 includes a fluorinated ether compound, the rechargeable lithium battery 10 may have a remarkably-improved cycle-life. Furthermore, the porous layer 42 firmly retains the electrolyte solution around at least one of the electrodes.

The porous layer 42 prevents or reduces the electrochemical decomposition of the separator 40a. The fluorinated ether compound prevents or reduces the electrochemical oxidation decomposition of the electrolyte solution 43. These factors may remarkably-improve cycle-life of the rechargeable lithium battery.

In addition, the porous layer 42 may be formed on both sides of the substrate 41. Such a separator may further improve the cycle-life.

In addition, since the second pores 42a have a larger average size than the first pores 41a, the separator 40a may be prevented from being clogged by sediment. Accordingly, cycle-life may be further improved.

In addition, the porosity of the porous layer 42 is greater than the porosity of the substrate 41. That is, the total pore size of the second pores 42a is greater than that of the first pores 41a. As such, the separator 40a may be prevented from being clogged. Accordingly, a cycle-life may be further improved.

The following examples illustrate embodiments of the present invention in more detail. These examples, however, should not in any sense be interpreted as limiting the scope of the present invention.

### Example 1

A positive active material slurry was prepared by dispersing 90 mass % of a solid solution oxide Li_{1.20}Mn_{0.55}Co_{0.10}Ni_{0.15}O₂, 6 mass % of KETJEN BLACK, and 4 mass % of polyvinylidene fluoride in N-methyl-2-pyrrolidone. The slurry was coated and dried on an aluminum current collecting foil, forming a positive active material layer. The positive active material layer was pressed to have a density of 2.3 g/cm³ using a presser.

A negative active material slurry was prepared by dispersing 96 mass % of artificial graphite and 4 mass % of polyvinylidene fluoride in N-methyl-2-pyrrolidone. The slurry was coated and dried on an aluminum current collecting foil as a current collector to form a negative active material layer. The negative active material layer was pressed to have a density of 1.45 g/cm³ using a presser.

Next, an aramid resin (poly[N,N′-(1,3-phenylene)isophthalamide] manufactured by Sigma-Aldrich Japan Co. Ltd.) was mixed with a water-soluble organic solvent in a mass ratio of 5.5:94.5, preparing a coating solution. The water-soluble organic solvent was prepared by mixing dimethyl acetamide (DMAc) and tripropyleneglycol (TPG) in a mass ratio of 50:50. A porous polyethylene film (thickness of 13 μm and porosity of 42%) was used as the substrate. The coating solution was coated to be 2 μm thick on both sides of the substrate. Then, the coated substrate was placed in a coagulating solution to solidify the resin, thereby fabricating a separator. Herein, the coagulating solution was prepared by mixing water, dimethyl acetamide (DMAc), and tripropyleneglycol (TPG) in a volume ratio of 50:25:25. The separator was cleaned and dried to remove the water and the water-soluble organic solvent.

The separator was disposed between the positive and negative electrodes, fabricating an electrode structure. The electrode structure was inserted in a test container.

Then, an electrolyte solution was prepared by dissolving LiPF₆ (to a concentration of 1.15 mol/L) in a solvent prepared by mixing ethylene carbonate (EC), dimethyl carbonate (DMC), and HCF₂CF₂OCH₂CF₂CF₂H (D2 manufactured by Daikin Industries Ltd.) in a volume ratio of 15:35:50.

The electrolyte solution was injected in the test container so that the electrolyte solution could penetrate into the pores in the separator. According to this process, a rechargeable lithium battery cell was fabricated.

### Example 2

A rechargeable lithium battery cell was fabricated according to the same method as Example 1 except that the separator was fabricating in the following method.

A coating solution was prepared by mixing a polyamideimide resin (MS1700 manufactured by ARKEMA Inc.) and a water-soluble organic solvent in a mass ratio of 5:95. The water-soluble organic solvent was the same as Example 1. A porous polyethylene film (a thickness of 19 μm and porosity of 40%) was used as the substrate. Then, the coating solution was coated to be 1 μm thick on one surface of the substrate. The coated substrate was placed in a coagulating solution in order to solidify the resin, thereby fabricating a separator. The coagulation solution was the same as Example 1. The separator was cleaned and dried to remove the water and the water-soluble organic solvent from the separator.

### Example 3

A rechargeable lithium battery cell was fabricated according to the same method as Example 1 except that the separator was fabricated in the following method.

A coating solution was prepared by mixing a polyvinylidene fluoride resin and a water-soluble organic solvent in a mass ration of 6.5:93.5. The water-soluble organic solvent was the same as Example 1. A porous polyethylene film (a thickness of 16 μm and porosity of 41%) was used as the substrate. Then, the coating solution was coated to be 2 μm thick on both sides of the substrate. The coated substrate was placed in a coagulating solution to solidify the resin therein, thereby fabricating a separator. The coagulating solution was the same as Example 1. Then, the separator was cleaned and dried to remove the water and the water-soluble organic solvent from the separator.

### Comparative Example 1

A rechargeable lithium battery cell was fabricated according to the same method as Example 1 except that polyethylene film (HIPORE ND420 manufactured by Asahi Chemical Industry Co. Ltd.) was used as a separator.

The following Table 1 shows characteristics of each separator according to Examples 1 to 3 and Comparative Example 1.

TABLE 1

| | | Comparative | | | |
|---|---|---|---|---|---|
| | | Example 1 | Example 1 | Example 2 | Example 3 |
| Total thickness of | μm | 20 | 17 | 20 | 20 |
| separator | | | | | |
| Thickness of | μm | — | 2 μm on each | 1 μm on one | 2 μm on each |
| porous layer | | | side | side | side |
| Avg diameter of | μm | — | 0.1 | 0.1 | 0.1 |
| first pore | | | | | |
| Avg diameter of | μm | — | 2 | 2 | 2 |
| second pore | | | | | |
| Porosity of | % | 44 | 50 | 39 | 34 |
| separator | | | | | |
| Transparency | Sec/100 cc | 300 | 260 | 330 | 300 |
| JIS P8117 | | | | | |
| Material of porous | | None | aramid | polyamide | polyvinylidene |
| layer | | | | imide | fluoride |

### Evaluation 1: Cycle-Life of Rechargeable Lithium Battery Cell

Each rechargeable lithium battery cell according to Examples 1 to 3 and Comparative Example 1 were evaluated to determine cycle characteristics (charge voltage: 4.65 V, discharge-ending voltage: 2.00 V) at room temperature (about 25° C.). In the cycle-life evaluation, in one cycle, a rechargeable lithium battery cell was discharged from a charge voltage to a discharge-ending voltage and charged up to a charge voltage. The discharge capacity was measured using a TOSCAT3000 (manufactured by Dongyang System Co. Ltd.).

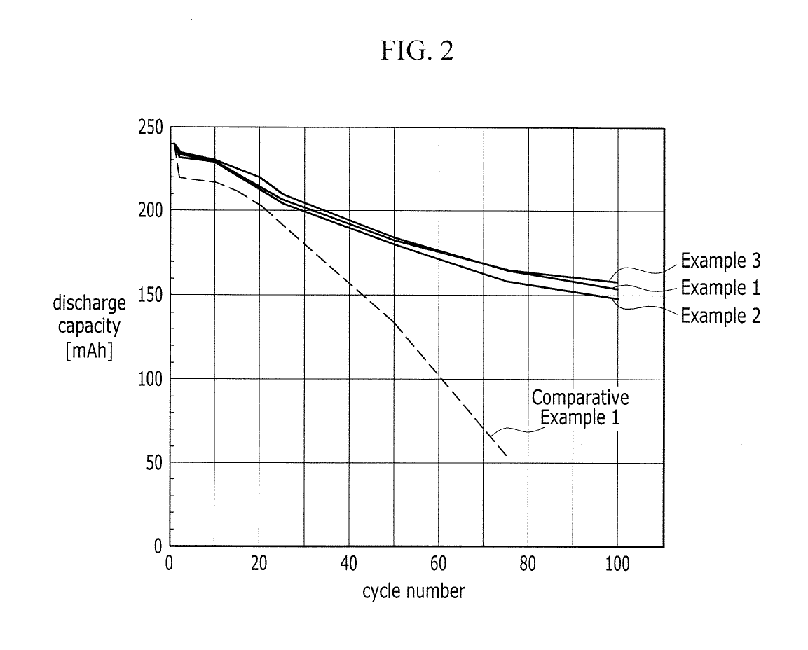

0.27 mA/cm² was applied to the Examples and Comparative Example cells at the first cycle, and 2.7 mA/cm² was applied to the cells at the 2nd to 200th cycles. In other words, the current applied at the first cycle was smaller than the current applied at the 2nd and greater cycles. The reason for this procedure, i.e., the charge and discharge being slowly performed at the first cycle, was to form the SEI at the negative electrode. The results of the testing are illustrated in FIG. 2.

FIG. 2 is a graph of the cycle-life of the rechargeable lithium battery cells according to Examples 1 to 3 and Comparative Example 1. Referring to FIG. 2, the rechargeable lithium battery cell according to Comparative Example 1 had a sharply deteriorated discharge capacity, not only at the first cycle, but also, as the number of cycles of the cell increased. However, the rechargeable lithium battery cells according to Examples 1 to 3 maintained discharge capacity closer to the initial discharge capacity as the number of cycles increased. In other words, the rechargeable lithium battery cells according to Examples 1 to 3 had improved cycle-life compared with the lithium battery cell according to Comparative Example 1.

The rechargeable lithium battery cells according to Examples 1 to 3 included a separator including a porous layer and an electrolyte solution including a fluorinated ether compound. These cells had improved cycle-life. In addition, a separator including a porous layer on both sides of a substrate (Examples 1 and 3) further improved cycle-life of a rechargeable lithium battery cell when compared to a separator including a porous layer only on one side (Example 2).

### Examples 4 to 8 and Comparative Examples 2 and 3

Rechargeable lithium battery cells were fabricated according to the same method as Example 1 except that electrolyte solutions were prepared to have compositions as provided in the following Table 2.

TABLE 2

| | Electrolyte solution |
|---|---|
| Example 4 | LiPF₆ concentration = 1.15 mol/l |
| | Volume ratio of |
| | EC:DMC:EMC:HCF₂CF₂OCH₂CF₂CF₂H of 15:20:15:50 |
| Example 5 | LiPF₆ concentration = 1.15 mol/1 |
| | Volume ratio of FEC (monofluoroethylene |
| | carbonate):DMC:HCF₂CF₂OCH₂CF₂CF₂H |
| | of 15:35:50 |
| Example 6 | LiPF₆ concentration = 1.40 mol/l |
| | Volume ratio of |
| | FEC:DMC:HCF₂CF₂OCH₂CF₂CF₂H of 15:35:50 |
| Example 7 | LiPF₆ concentration = 1.15 mol/l |
| | Volume ratio of FEC:MFA(difluoro acetic acid methyl |
| | ester):HCF₂CF₂OCH₂CF₂CF₂H of 15:35:50 |
| Example 8 | 0.5 mass % of succinonitrile (SN) was added to the |
| | electrolyte solution of Example 1 based on the total mass of |
| | the electrolyte solution |
| Comparative | LiPF₆ concentration = 1.15 mol/l |
| Example 2 | EC:EMC in a volume ratio of 30:70 |
| Comparative | LiPF₆ concentration = 1.40 mol/l |
| Example 3 | EC:FEC:DMC:EMC in a volume ratio of 15:15:60:10 |
| | 1 mass % of VC (vinylene carbonate) and 0.2 mass % of |
| | LiBF₄ based on the total mass of the electrolyte solution |

### Evaluation 2: Cycle-Life of Rechargeable Lithium Battery Cell

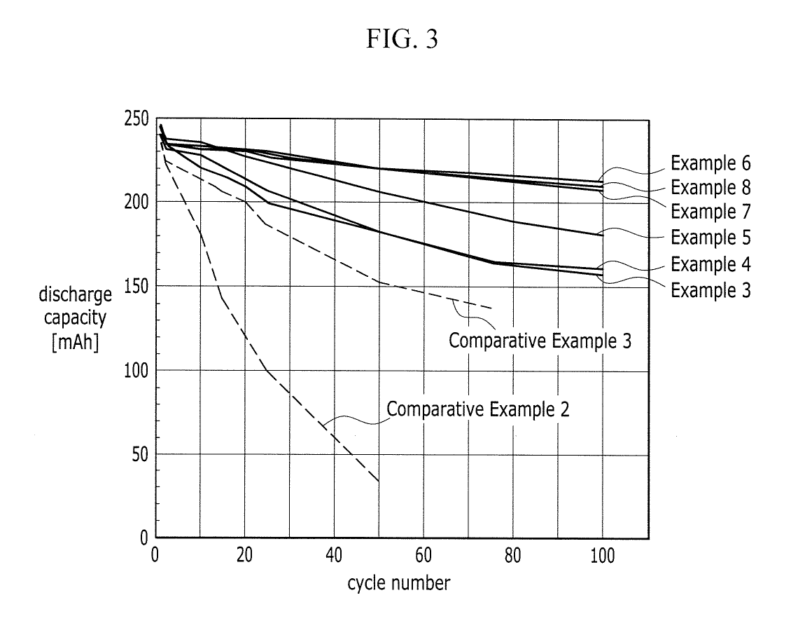

The rechargeable lithium battery cells according to Examples 4 to 8 and Comparative Examples 2 and 3 were evaluated regarding cycle characteristics (charge voltage: 4.65 V, discharge ending voltage: 2.00 V). The results are illustrated in FIG. 3.

FIG. 3 is a graph of the cycle-life of the rechargeable lithium battery cells according to Examples 4 to 8 and Comparative Examples 2 and 3. Referring to FIG. 3, the rechargeable lithium battery cells according to Examples 4 to 8 had improved cycle-life compared with those according to Comparative Examples 2 and 3.

The rechargeable lithium battery cells according to Examples 4 to 8 included a separator including a porous layer and an electrolyte solution including a fluorinated ether compound and had an improved cycle-life. In addition, when monofluoroethylene carbonate was substituted for ethylene carbonate the rechargeable lithium battery cell had improved cycle-life. When LiPF₆ was included in a higher concentration, the rechargeable lithium battery cell had improved cycle-life. Furthermore, when difluoro acetic acid methyl ester was substituted for ethylmethyl carbonate, the rechargeable lithium battery cell had improved cycle-life. In addition, when succinonitrile was added to the electrolyte solution, the rechargeable lithium battery cell had improved cycle-life.

The rechargeable battery cells according to Examples 1 to 8 and Comparative Examples 1 to 3 were evaluated as follows.

When the rechargeable lithium battery cell according to Comparative Example 1 was repetitively charged and discharged, a particle-shaped material was piled up on an electrode (i.e., sediment built up at an electrode). The sediment included a mixture of organic material and inorganic material. The sediment impregnated pores of the separator and clogged the separator. The clogged separator tends to hinder movement of the electrolyte.

In addition, when the rechargeable lithium battery cells according to Comparative Examples 2 and 3 were repetitively charged and discharged, a sediment material with high viscosity accumulated at the surface of each electrode. The sediment included a large amount of an organic material component. The sediment impregnated pores of the separator and clogged the separator.

Just as in Comparative Example 1, the particle-shaped sediment was precipitated in the separators of Examples 1 to 8. However, a porous layer including pores with a large diameter and high porosity was formed on the surface of a substrate. Accordingly, it may be more difficult to clog the separators of Examples 1 to 8 when compared to Comparative Examples 1 to 3. As Comparative Examples 1 to 3 did not include the porous layer, the separators of Comparative Examples 1 to 3 became more clogged than the substrate of Examples 1 to 8.

Therefore, the reason that the rechargeable lithium battery cells according to Comparative Examples 1 to 3 had deteriorated cycle-lives compared with the one according to Examples 1 to 8 may be a clogged separator.

### Examples 9 to 17 and Comparative Example 4

Rechargeable lithium battery cells were fabricated according to the same method as Example 1 except that the electrolyte solution was prepared to have a composition according to the following Table 3.

TABLE 3

| | Electrolyte solution | | | |
|---|---|---|---|---|
| | | FEC | DMC | |
| | LiPF₆ | (volume | (volume | HCF₂CF₂OCH₂CF₂CF₂H |
| | (mol/l) | %) | %) | (volume %) |
| Example 9 | 1.40 | 20 | 70 | 10 |
| Example 10 | 1.40 | 20 | 60 | 20 |
| Example 11 | 1.40 | 20 | 50 | 30 |
| Example 12 | 1.40 | 20 | 47 | 33 |
| Example 13 | 1.40 | 20 | 43 | 37 |
| Example 14 | 1.40 | 20 | 40 | 40 |
| Example 15 | 1.40 | 20 | 30 | 50 |
| Example 16 | 1.40 | 20 | 25 | 55 |
| Example 17 | 1.40 | 20 | 20 | 60 |
| Comparative | 1.40 | 20 | 80 | 0 |
| Example 4 | | | | |

### Evaluation 3: Cycle-Life of Rechargeable Lithium Battery Cell

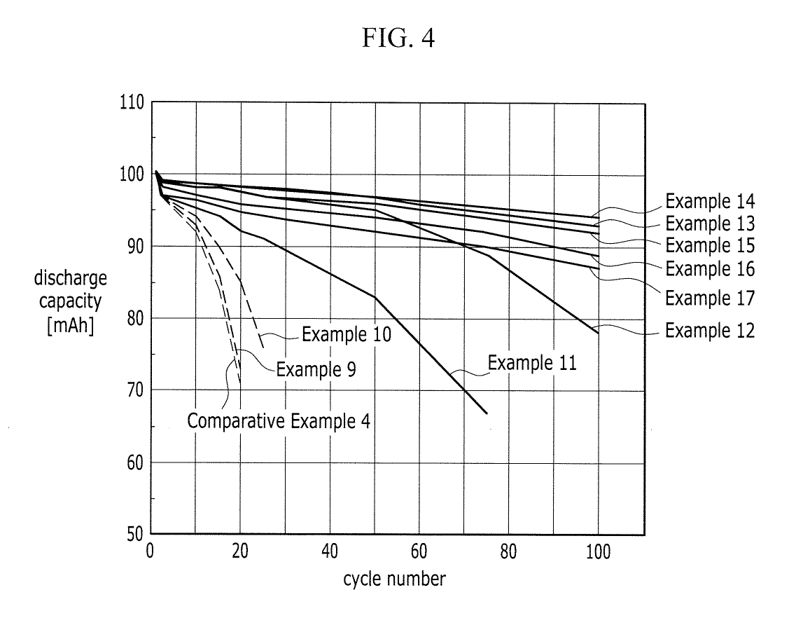

The rechargeable lithium battery cells according to Examples 9 to 17 and Comparative Example 4 were evaluated regarding cycle-life (charge voltage: 4.65 V, discharge-ending voltage: 2.00 V). The results are illustrated in FIG. 4.

FIG. 4 is a graph of the cycle-life of the rechargeable lithium battery cells according to Examples 9 to 17 and Comparative Example 4. Referring to FIG. 4, the rechargeable lithium battery cells according to Examples 11 to 17 had more improved cycle-life than that according to Comparative Example 4.

In particular, the rechargeable lithium battery cells including a separator including a porous layer and an electrolyte solution including a fluorinated ether compound had improved cycle-life. In addition, the rechargeable lithium battery cells according to Examples 13 to 15 had better cycle-life than those according to other embodiments. Furthermore, the rechargeable lithium battery cells according to Examples 11, 12, 16, and 17 had better cycle-life than Examples 9 and 10. Accordingly, the fluorinated ether compound may be included in a range of 30 to 60 volume %, and in other embodiments, 35 to 50 volume %, based on the total amount of the electrolyte solution.

### Examples 18 to 25

Rechargeable lithium battery cells were fabricated according to the same method as Example 1 except that they included an electrolyte solution having a composition provided in the following Table 4.

TABLE 4

| | Electrolyte solution | | | |
|---|---|---|---|---|
| | | FEC | DMC | |
| | LiPF₆ | (volume | (volume | HCF₂CF₂OCH₂CF₂CF₂H |
| | (mol/l) | %) | %) | (volume %) |
| Example 18 | 1 | 7 | 63 | 40 |
| Example 19 | 1.4 | 7 | 63 | 40 |
| Example 20 | 1.4 | 10 | 60 | 40 |
| Example 21 | 1.4 | 13 | 57 | 40 |
| Example 22 | 1.4 | 15 | 45 | 40 |
| Example 14 | 1.4 | 20 | 40 | 40 |
| Example 23 | 1.4 | 23 | 37 | 40 |
| Example 24 | 1.4 | 30 | 30 | 40 |
| Example 25 | 1.4 | 33 | 27 | 40 |

### Evaluation 4: Cycle-Life of Rechargeable Lithium Battery Cell

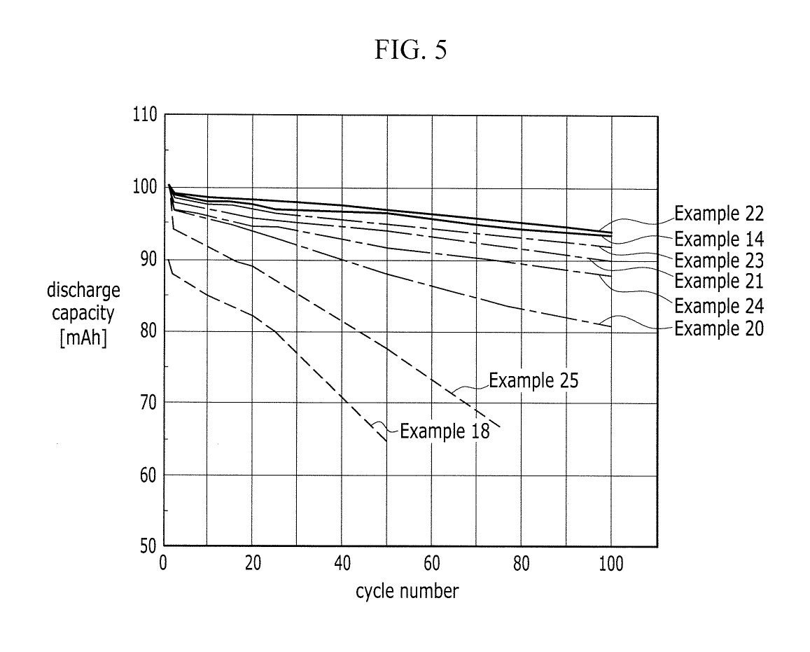

Each rechargeable lithium battery cell according to Example 14 and 18 to 25 was evaluated regarding cycle-life (charge voltage: 4.65 V, discharge-ending voltage: 2.00 V). The results are illustrated in FIG. 5.

FIG. 5 is a graph of the cycle-life of the rechargeable lithium battery cells according to Examples 14, 18, and 20 to 25. Referring to FIG. 5, the rechargeable lithium battery cells according to Examples 14 and 20 to 24 had very good cycle-life.

The rechargeable lithium battery cells included a separator including a porous layer and an electrolyte solution including a fluorinated ether compound and monofluoroethylene carbonate and thus, had improved cycle-life.

The rechargeable lithium battery cells according to Examples 14 and 22 had better cycle-lives than those according to other exemplary embodiments. In addition, the rechargeable lithium battery cells according to Examples 20, 21, 23, and 24 had better cycle-lives than those according to Examples 18 and 25. As such, the monofluoroethylene carbonate may be included in an amount of 10 to 30 volume % and in some embodiments, 15 to 20 volume %, based on the total volume of the electrolyte solution.

FIG. 5 does not show the graph of the rechargeable lithium battery cell according to Example 19. This is because the LiPF₆ was not sufficiently dissolved in the electrolyte solution.

### Examples 26 to 34

Rechargeable lithium battery cells were fabricated according to the same method as Example 1 except that an electrolyte solution was prepared to have a composition according to the following Table 5.

TABLE 5

| | Electrolyte solution | | | |
|---|---|---|---|---|
| | | FEC | DMC | |
| | LiPF₆ | (volume | (volume | HCF₂CF₂OCH₂CF₂CF₂H |
| | (mol/l) | %) | %) | (volume %) |
| Example 26 | 1.00 | 15 | 45 | 40 |
| Example 27 | 1.10 | 15 | 45 | 40 |
| Example 28 | 1.15 | 15 | 45 | 40 |
| Example 29 | 1.25 | 15 | 45 | 40 |
| Example 30 | 1.30 | 15 | 45 | 40 |
| Example 22 | 1.40 | 15 | 45 | 40 |
| Example 31 | 1.45 | 15 | 45 | 40 |
| Example 32 | 1.48 | 15 | 45 | 40 |
| Example 33 | 1.50 | 15 | 45 | 40 |
| Example 34 | 1.55 | 15 | 45 | 40 |

### Evaluation 5: Cycle-Life of Rechargeable Lithium Battery Cell

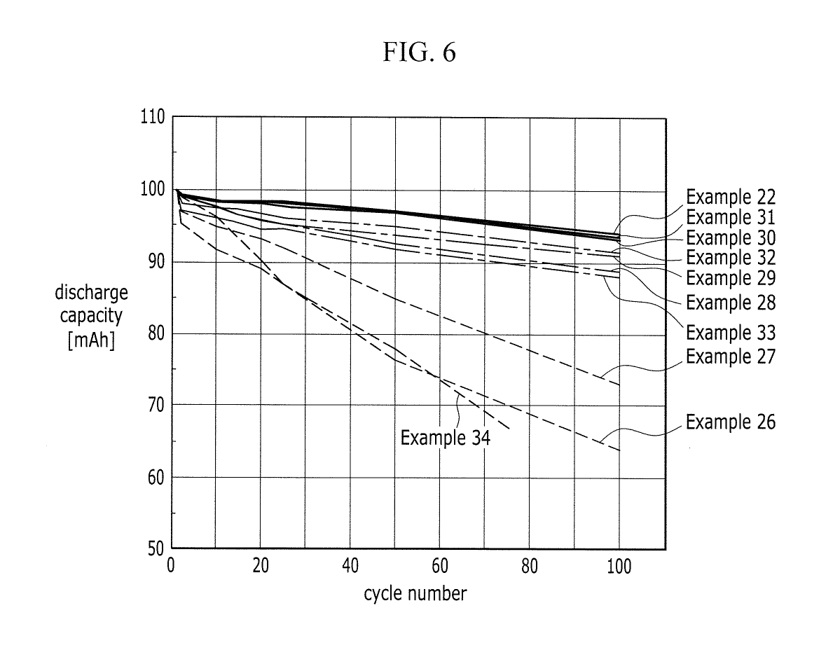

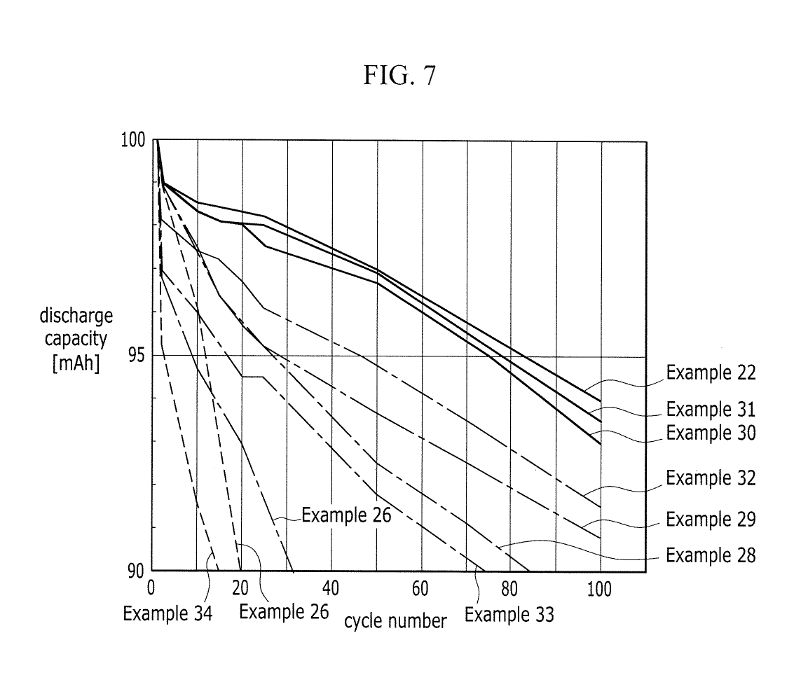

The rechargeable lithium battery cells according to Examples 22 and 26 to 34 were evaluated regarding cycle-life (charge voltage: 4.65 V, discharge-ending voltage: 2.00 V). The results are illustrated in FIGS. 6 and 7.

FIG. 6 is a graph of the cycle-life of the rechargeable lithium battery cells according to Examples 26 to 34, FIG. 7 is an enlarged graph of FIG. 6 showing discharge capacity in a range of 90 to 100 mAh. Referring to FIGS. 6 and 7, the rechargeable lithium battery cells according to Example 22 and 28 to 33 had very good cycle-life.

The rechargeable lithium battery cells including a separator including a porous layer and an electrolyte solution including a fluorinated ether compound and monofluoroethylene carbonate had improved cycle-lives.

In addition, the rechargeable lithium battery cells according to Examples 22, 30, and 31 had better cycle-life than other exemplary embodiments. Furthermore, the rechargeable lithium battery cells according to Examples 28, 29, 32, and 33 had better cycle-lives than those according to Examples 26, 27, and 34. Accordingly, LiPF₆ included in a range of 1.15 to 1.5 mol/L had better effects than LiPF₆ included outside that range. Furthermore, cells including LiPF₆ in a range 1.3 to 1.45 mol/L had even more improved effects.

In addition, when the monofluoroethylene carbonate is included in a range of greater than or equal to 10 volume % to greater than or equal to 30 volume %, and the fluorinated ether compound is included in a range of greater than 0 to greater than or equal to 60 volume %, LiPF₆ was able to be dissolved in an electrolyte solution. Accordingly, the monofluoroethylene carbonate and LiPF₆ may have a volume ratio within this range.

In addition, when greater than 30 volume % of the fluoroethylene carbonate and greater than 60 volume % of the fluorinated ether compound were included, and the electrolyte solution had a liquid temperature of less than 20° C., monofluoro ethylene carbonate was precipitated. Accordingly, the electrolyte solution should maintain a liquid temperature of greater than or equal to 20° C.

### Examples 35 to 45

A rechargeable lithium battery cell was fabricated according to the same method as Example 1 except that the electrolyte solution was prepared having a composition according to the following Table 6.

TABLE 6

| | Electrolyte solution | | | |
|---|---|---|---|---|
| | | FEC | DMC | |
| | LiPF₆ | (volume | (volume | HPE (included at 40 |
| | (mol/l) | %) | %) | volume %) |
| Example 30 | 1.30 | 15 | 45 | H(CF₂)₂CH₂O(CF₂)₂H |
| Example 35 | 1.30 | 15 | 45 | H(CF₂)₂OCH₂CH₃ |
| Example 36 | 1.30 | 15 | 45 | H(CF₂)₂OCH₂CF₃ |
| Example 37 | 1.30 | 15 | 45 | CF₃CF₃CH₂O(CF₂)₂H |
| Example 38 | 1.30 | 15 | 45 | CF₃CH₂OCHF₂ |
| Example 39 | 1.30 | 15 | 45 | CF₃CF₂CH₂OCHF₂ |
| Example 40 | 1.30 | 15 | 45 | CF₃CHFCF₂OCH₃ |
| Example 41 | 1.30 | 15 | 45 | CF₃CHFCF₂OCH₂CH₃ |
| Example 42 | 1.30 | 15 | 45 | CF₃CHFCH₂CH₂OCHF₂ |
| Example 43 | 1.30 | 15 | 45 | H(CF₂)₂OCH₃ |
| Example 44 | 1.30 | 15 | 45 | H(CF₂)₂CH₂OCF₂CHFCH₃ |
| Example 45 | 1.30 | 15 | 45 | C₂F₅CH₂OCF₂CHFCF₃ |

### Evaluation 6: Cycle-Life of Rechargeable Lithium Battery Cell

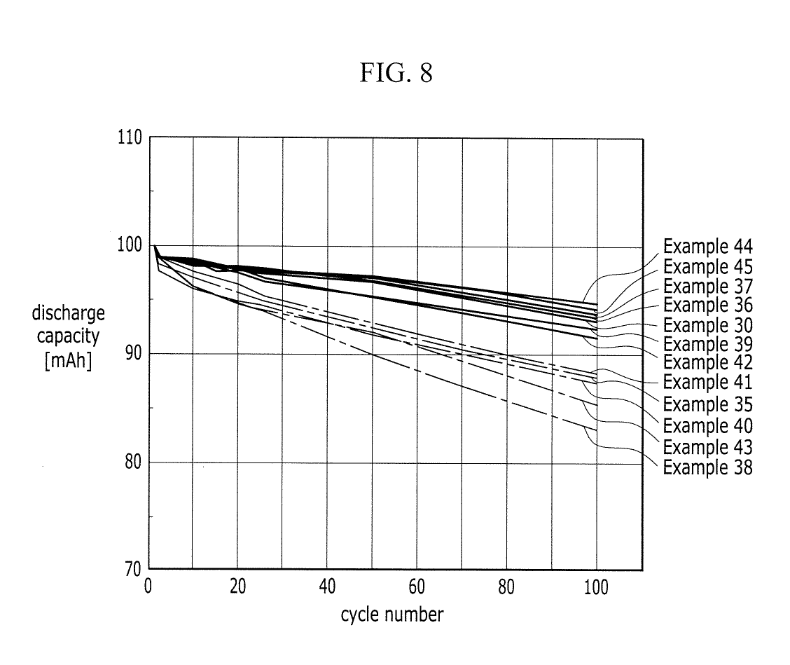

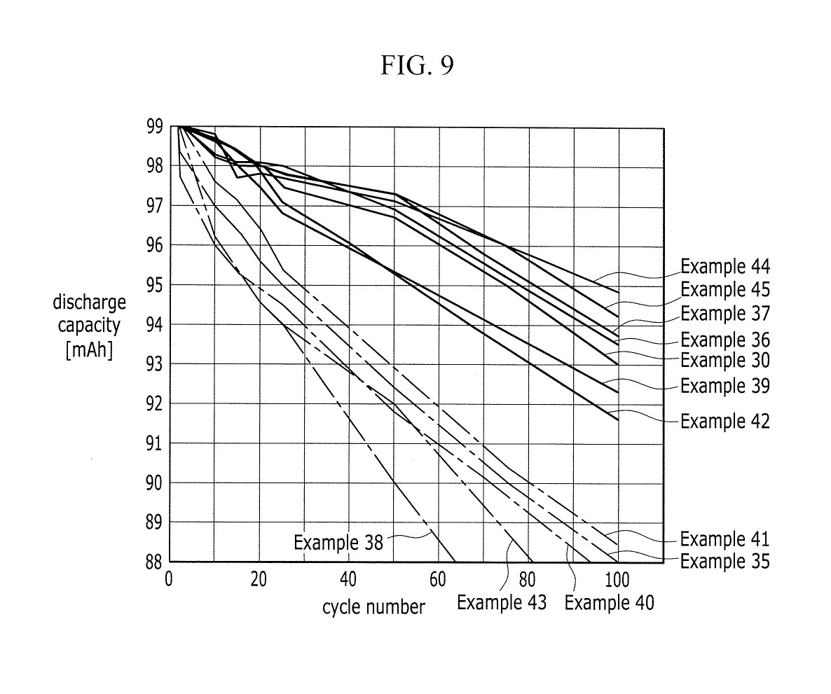

Each rechargeable lithium battery cell according to Examples 30 and 35 to 45 was evaluated regarding cycle-life (charge voltage: 4.65 V, discharge-ending voltage: 2.00 V). The results are illustrated in FIGS. 8 and 9.

FIG. 8 is a graph of the cycle-life of the rechargeable lithium battery cells according to Examples 30 and 35 to 45, and FIG. 9 is an enlarged graph of FIG. 8 showing the discharge capacity in a range of 88 to 99 mAh. Referring to FIGS. 8 and 9, the rechargeable lithium battery cells according to Examples 30 and 35 to 45 had very good cycle-life.

The rechargeable lithium batteries included a separator including a porous layer and an electrolyte solution including a fluorinated ether compound and monofluoroethylene carbonate and had improved cycle-life.

The rechargeable lithium batteries according to Examples 30, 36, 37, 39, 42, 44, and 45 had better cycle-life than those according to Examples 35, 38, 40, 41, and 43. Accordingly, in some embodiments, the fluorinated ether compound may include HCF₂CF₂OCH₂CF₂CF₂H, H(CF₂)₂OCH₂CF₃, CF₃CF₂CH₂O(CF₂)₂H, CF₃CF₂CH₂OCHF₂, CF₃CHFCF₂CH₂OCHF₂, H(CF₂)₂CH₂OCF₂CHFCF₃, and C₂F₅CH₂OCF₂CHFCF₃.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and equivalents thereof.

### DESCRIPTION OF SOME OF THE REFERENCE NUMERALS

| | |
|---|---|
| 10: lithium ion rechargeable battery | 20: positive electrode |
| 30: negative electrode | 40: separator layer |
| 40a: separator | 41: substrate |
| 41a: first pore | 42: porous layer |
| 42a: second pore | 43: electrolyte solution |

What is claimed is:

1. A separator for a rechargeable lithium battery, the separator comprising:
a substrate comprising a plurality of first pores; and
a porous layer on a surface of the substrate, the porous layer comprising a plurality of second pores,
wherein the second pores have a larger average size than the first pores.

2. The separator for a rechargeable lithium battery of claim 1, wherein the porous layer is on both surfaces of the substrate.

3. The separator for a rechargeable lithium battery of claim 1, wherein the second pores have an average size in a range of about 1 μm to about 2 μm.

4. The separator for a rechargeable lithium battery of claim 1, wherein the first pores have an average size in a range of about 0.1 μm to about 0.5 μm.

5. The separator for a rechargeable lithium battery of claim 1, wherein the separator has a porosity in a range of about 39% to about 58%.

6. The separator for a rechargeable lithium battery of claim 1, wherein the porous layer has a higher porosity than the substrate.

7. The separator for a rechargeable lithium battery of claim 6, wherein the substrate has a porosity in a range of about 38% to about 44%.

8. The separator for a rechargeable lithium battery of claim 1, wherein the porous layer has a thickness in a range of about 1 μm to about 5 μm.

9. The separator for a rechargeable lithium battery of claim 8, wherein the separator has a total thickness in a range of about 10 μm to about 25 μm.

10. A rechargeable lithium battery comprising:
a positive electrode comprising a positive active material;
a negative electrode comprising a negative active material;
the separator according to claim 1 between the positive electrode and the negative electrode; and
an electrolyte solution comprising a fluorinated ether compound.

11. The rechargeable lithium battery of claim 10, wherein the porous layer is between the substrate of the separator and the negative electrode.

12. The rechargeable lithium battery of claim 10, wherein the porous layer is on both sides of the substrate of the separator.

13. The rechargeable lithium battery of claim 10, wherein the electrolyte solution is impregnated into the first and second pores.

14. The rechargeable lithium battery of claim 10, wherein the fluorinated ether compound is selected from the group consisting of 2,2,2-trifluoro ethyl methyl ether, 2,2,2-trifluoroethyl difluoro methyl ether, 2,2,3,3,3-penta fluoro propyl methyl ether, 2,2,3,3,3-pentafluoro propyl difluoro methyl ether, 2,2,3,3,3-penta fluoropropyl-1,1,2,2-tetrafluoroethyl ether, 1,1,2,2-tetra fluoro ethyl methyl ether, 1,1,2,2-tetra fluoro ethyl ether, 1,1,2,2-tetra fluoro ethyl propyl ether, 1,1,2,2-tetra fluoro ethyl butyl ether, 1,1,2,2-tetra fluoro ethyl isobutyl ether, 1,1,2,2-tetra fluoro ethyl isopentyl ether, 1,1,2,2-tetrafluoroethyl-2,2,2-trifluoro ethyl ether, 1,1,2,2-tetrafluoroethyl-2,2,3,3-tetra fluoro propyl ether, hexa fluoro isopropyl methyl ether, 1,1,3,3,3-penta fluoro-2-trifluoro methyl propyl methyl ether, 1,1,2,3,3,3-hexa fluoro propyl methyl ether, 1,1,2,3,3,3-hexa fluoro propyl ethyl ether, 2,2,3,4,4,4-hexafluorobutyl difluoro methyl ether, and combinations thereof.

15. The rechargeable lithium battery of claim 10, wherein the electrolyte solution comprises the fluorinated ether compound in a range of about 30 to about 60 volume % based on the total volume of the electrolyte solution.

16. The rechargeable lithium battery of claim 10, wherein the electrolyte solution further comprises monofluoroethylene carbonate.

17. The rechargeable lithium battery of claim 16, wherein the electrolyte solution comprises the monofluoroethylene carbonate in a range of about 10 to about 30 volume % based on the total volume of the electrolyte solution.

18. The rechargeable lithium battery of claim 10, wherein the electrolyte solution further comprises a lithium salt in a range of about 1.15 to about 1.5 mol/L.

19. An electrode assembly for a rechargeable lithium battery comprises:
a positive electrode comprises a positive active material;
a negative electrode comprises a negative active material; and
a separator between the positive electrode and the negative electrode, the separator comprising a substrate and a porous layer on a side of the substrate, the substrate comprising a plurality of first pores and the porous layer comprising a plurality of second pores,
wherein the second pores have a larger average size than the first pores, and wherein the porous layer is between the substrate and the negative electrode.
